(19) United States
(12) Patent Application Publication
(10) Pub. No.: US 2002/0116308 A1
(43) Pub. Date: Aug. 22, 2002

(54) Computerized asset verification system and method

(76) Inventor: Guy N. Cunningham, St. Louis, MO (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/078,733

(22) Filed: Feb. 19, 2002

Related U.S. Application Data
(60) Provisional application No. 60/270,482, filed on Feb. 21, 2001.

(51) Int. Cl. G06F 17/60

(52) U.S. Cl. 705/35

(57) ABSTRACT

A provider of an asset verification system contracts with financial institutions and verifiers to provide an automated solution for verifications of deposits that is available in three service levels—as semi-customized software, as hosted software, or as an outsourced service. As a semi-customized software package, a financial institution may utilize the asset verification system and method for receiving and processing both the verification of deposits forms and any fees charged for the transaction. The asset verification system provides the financial institution with the ability to access the functionality of the system over the Internet, and may be configured to directly receive the verification of deposits forms and payment on behalf of the financial institution. Alternatively, the asset verification system may be utilized by the financial institution in an outsourced manner to receive and process both the verification of deposits forms and the payment for the transaction. The financial institution places interface for the asset verification system onto its own computer network, and asset verification system connects to this interface via a communications link. Alternatively, the asset verification system will provide the financial institution with the ability to access the functionality of the system over the internet as hosted software, and may be configured to directly receive the verification of deposit forms and payment on behalf of the financial institution.

### CROSS-REFERENCE TO RELATED APPLICATIONS

The present application claims priority from provisional U.S. Application No. 60/270,482, filed on Feb. 21, 2001.

### STATEMENT REGARDING FEDERALLY SPONSORED RESEARCH

Not Applicable.

### BACKGROUND OF THE INVENTION

The present invention relates to a system and method for asset verification, and in particular, to a method for automating and facilitating deposit account information by providing a central system through which status inquiries and account information may be exchanged. The system is adapted to demand deposit (checking and savings) accounts, and optionally may be expanded to include time deposit (CD's) accounts, asset accounts (stocks, bonds, etc.), and to verify loan/mortgage balance and payoff information.

Systems and methods for the verification of employment and salary information are commonly utilized throughout industry. For example, TALX Corporation operates The Work Number for Everyone®, the nation's leading automated employment and salary verification service.

Everyday banks and brokerage firms across the country receive thousands of pieces of mail and thousands of faxes requesting that these financial institutions confirm, or verify, the deposit information of their account holders. These requests come primarily from lenders determining whether or not to lend money to the respective account holder. These requests may also come from public assistance agencies determining whether someone qualifies for social aid such as food stamps, Medicaid, etc.

Fulfillment of these verification of deposit requests is a significant drain upon the resources of the receiving financial institutions. By and large, most financial institutions process these verifications in a manual way, spending valuable time and staff resources to complete the verification of deposits forms and mail or fax them back to the verifier. These resources could be used in other, more productive, mission critical tasks.

Currently a large financial institution can expect to receive at least two verifications requests for every 100 demand deposit accounts (checking and savings accounts) at an average total cost of $5 per verification. Each verification request is processed in a similar manner. The originating verifier mails or faxes a form to the financial institution. This form contains account information including name of the account holder, Social Security Number, and account number. This form is received by the institution and routed to the appropriate response section.

The financial institution then completes the verification form manually, either by hand, or by printing a screen of account information from their customer information files. Once the verification form has been completed, the form is mailed or faxed back to the originator. Under the best of circumstances this process can take 1-2 days; however, under normal circumstances this process takes between 4 and 8 days.

In an effort to make smart loan decisions, mortgage companies have set in place underwriting standards that determine the characteristics or qualities of an acceptable loan. Historically, the use of Loan-to-Value, Debt-to-Income, and Payment-to-Income ratios were the primary means of determining an applicant's ability to make regular payments on a mortgage. Today, mortgage companies use computer programs that score an applicant's credit history and mortgage payment ability. These scoring tools have greatly increased the predictive accuracy of payment ability.

Although automated scoring techniques are highly accurate, there is still a need for direct verification of the information contained within a mortgage application. Even with these automated tools, fraud within the mortgage industry is at an all-time high with current figures totaling more than 80-billion dollars a year.

Two factors work against one another in the pursuit of the verification of deposits. On the one hand, recent studies have determined that more than 50% of the households in the U.S. have less than $1,000 in assets. This increases the need for verifying the value of a loan applicant's deposit account balance. On the other hand, the current method for obtaining this information is fragmented, cumbersome and costly, as each individual institution having an account for an applicant must be contacted independently.

Verification of Deposits is one of three lengthy verification processes, together with Verification of Employment and Verification of Property or Collateral Assessment (real estate appraisal). These three processes provide a lender with an extra step of needed due diligence in their fight against fraud. Today, the majority of the loan underwriting process is done electronically (application, credit report, credit score, mortgage score, preliminary approval, and loan delivery). With the rapid growth of online mortgage origination, the mortgage industry is quickly approaching a time when it will not be able to tolerate lengthy, manual verification processes. The banking industry is also experiencing a similar type of transformation. Rapid consolidation coupled with the increased use of online banking is creating an environment where banks must seek out creative ways in which to reduce expenses and generate additional revenue.

At the same time, according to numerous industry groups, fraud in the mortgage origination process is increasing. The top five fraudulent documents are W-2's, tax returns, financial statements, verifications of employment, and verification of deposits. Over the past several years, firms have been at work automating two of these processes. A few firms offer automated verification of employment and there are several large databases of property/collateral assessment information.

To date, no system or method for automating the verification of deposits process exists. Accordingly, there is a need in the industry for a system and method providing secure access to a single source of information for parties seeking to verify assets contained in a deposit account, simplifying the process and increasing the possible number of verification of deposits transactions that can occur, while reducing the overall cost.

### BRIEF SUMMARY OF THE INVENTION

Among the several objects and advantages of the present invention are:

The provision of an asset verification system which utilizes the Internet to automate verification of deposit account information;

The provision of an asset verification system which utilizes optical character recognition and workflow automation technology to facilitate the verification of deposit account information;

The provision of an asset verification system which eliminates a significant portion of the cost of responding manually to verification of deposit account requests;

The provision of an asset verification system which provides a substantial fee revenue from these transactions;

The provision of an asset verification system which provides verifiers with a single, nationwide source for automated, verification of a credit applicant's demand deposit accounts; and

The provision of an asset verification system which meets the needs of the banking community with significant cost reductions and a sizable revenue stream.

Briefly stated, the asset verification system of the present invention provides financial institutions with an automated solution for verifications of deposits in three service levels—as an outsourced service, as hosted software, or as stand alone, semi-customized software.

In a first embodiment, the asset verification system of the present invention is utilized by a financial institution in an outsourced manner. The asset verification system of the present invention receives and processes both the Verification Of Deposits request forms and the payment for the transaction. The financial institution places an interface for the asset verification system onto its computer network, and the asset verification system connects to this interface through the Internet using secure data transmission technology. In the event that a financial institution does not have access to the Internet, and if the size of the institution warrants it, the asset verification system will use a direct, leased line connection to communicate with the financial institution. Under this scenario, the asset verification system enables the financial institution to reduce its staff and expenses by 60-90% depending upon the existing level of automation and the level of functionality selected.

In a first alternate embodiment, the asset verification system of the present invention provides the financial institution with the ability to access the functionality of the system over the Internet. The asset verification system receives the Verification Of Deposits request forms and payment on behalf of the financial institution. Under this scenario, the asset verification system will enable the financial institution to reduce its staff and expenses by 30-60% depending upon the existing level of automation and the level of functionality selected.

In an second alternate embodiment, as a semi-customized software package, a financial institution may utilize the asset verification system and method of the present invention for receiving and processing both the Verification Of Deposits request forms and any fees charged for the transaction. Under this scenario, the asset verification system of the present invention will enable the financial institution to reduce its staff and expenses by 40-70% depending upon the existing level of automation and the level of functionality selected.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an flowchart overview of the asset verification system and method of the present invention;

FIG. 2 is a flowchart illustration of the process for providing manual asset verification using the asset verification system and method of the present invention;

FIG. 3 is a flowchart illustration of the internal procedures for providing asset verification utilizing the asset verification system and method of the present invention; and

FIG. 4 is a flowchart illustration of the portion of the verification process handled by a financial institution as it utilizes the asset verification system and method of the present invention.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description clearly enables one skilled in the art to make and use the invention, describes several embodiments, adaptations, variations, alternatives, and uses of the invention, including what is presently believed to be the best mode of carrying out the invention.

The majority of all technical discussions will originate from the perspective of the outsourced service embodiment of the present invention. This is the core of the asset verification business model. The technology and infrastructure developed to deliver this functionality will be leveraged to provide both the hosted software embodiment, via the Internet or other communications link, and the stand-alone software embodiment of the present invention.

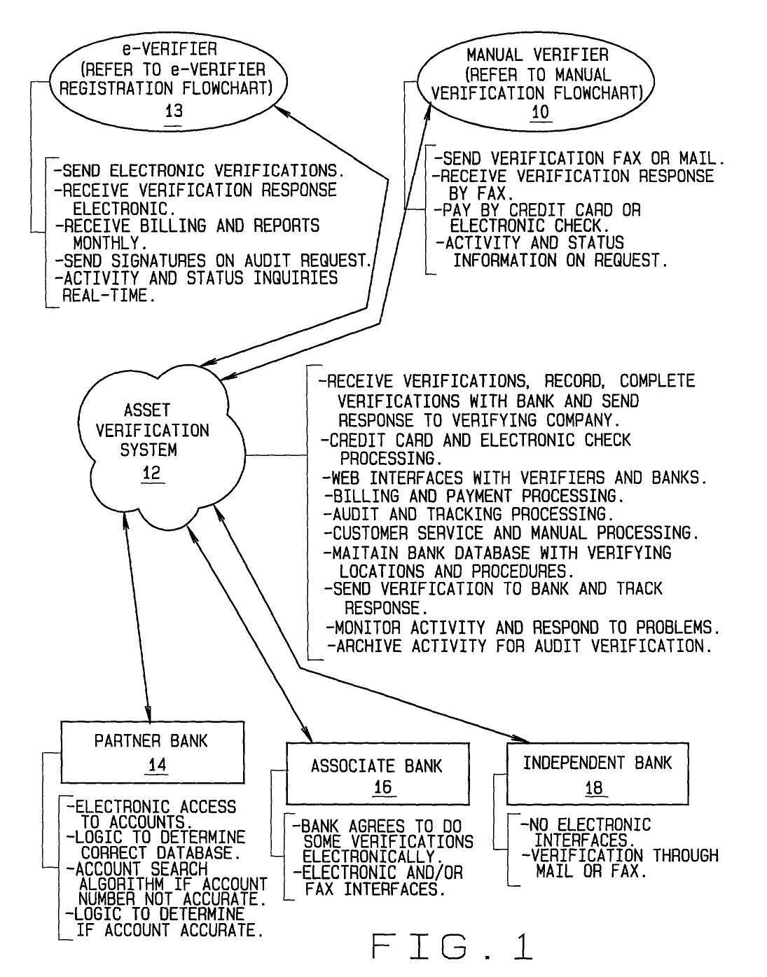

As seen in FIG. 1 manual asset verification requests (Box 10) are submitted to the asset verification system (Box 12) by a Verification Of Deposit (VOD) request form sent via U.S. Postal Service or via facsimile. When the VOD request form is received by the asset verification system (Box 12) with an accompanying payment for the processing fee, an operator, or verification specialist, will process the received form manually by utilizing an interface to complete a corresponding software form that transforms the manual VOD request form into an electronic transaction application. Manual processing of the received VOD forms may include manual data entry into a computer system of the information contained thereon, or may include the scanning and optical character recognition of data in a fully automated or semi-automated process. Information required to complete the electronic transaction application includes the identification of the requesting party and at least one asset query.

Alternatively, an electronic asset verification request (Box 13) containing the information required to complete the electronic transaction application may be submitted to the asset verification system (Box 12) through an input interface by a customer having electronic access, referred to as a subscriber or “e-Verifier”. Electronic access to the asset verification system by a customer optionally further provides for electronic billing and invoicing, digital signature transfers, and account activity and status inquiry requests.

The asset verification system (Box 12) additionally processes received payment information, such as credit card or electronic check information received with manual asset verification requests, or generates billing and payment processing information associated with customers having electronic access.

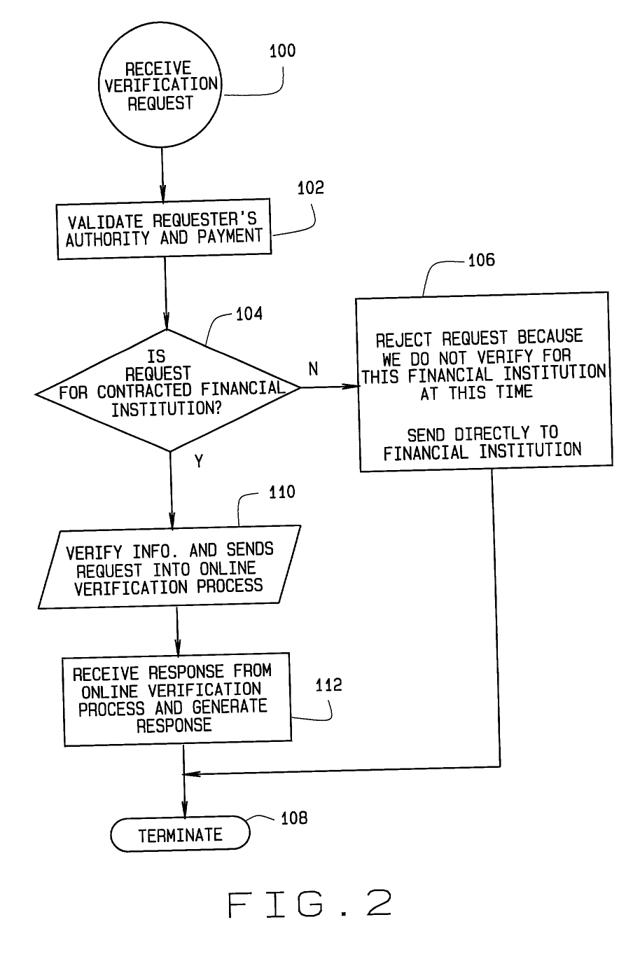

The electronic transaction application is then routed through the asset verification system (Box 12) to an appropriate financial institution identified in the asset verification request, for completion of the asset verification request, as seen in FIG. 2. An asset verification request is first received through the appropriate interface to the asset verification system (Box 100). The asset verification system initially determines if the request is from an authorized source, i.e. a paying customer, and verifies the associated payment information. (Box 102). Preferably, a request for asset verification is accompanied by the name of the requestor, a subscriber identification code, and contact information such as a name, address, and telephone number.

Next, the asset verification system determines if the assets for which verification is requested are located at a financial institution with which the asset verification system is contracted to provide information (Box 104). If the financial institution is not contracted with the asset verification system (Box 106), a suitable reply is generated, and the asset verification request is terminated (Box 108). If, however, the financial institution is contracted with the asset verification system to provide asset verification information, the asset verification system verifies the requested information and transmits a request to an interface at the financial institution (Box 110). Upon receipt of a reply from the financial institution, the asset verification system generates an asset verification report (Box 112), and completes the transaction.

As seen in FIG. 1, financial institutions may interact with the asset verification system (Box 12) on several different levels.

A Partner Bank (Box 14) is fully integrated with the asset verification system, providing an interface with electronic access to account information and account search services. Partner financial institutions interact with the asset verification system on an open level, providing electronic access to the financial institute's account system and databases, utilizing the asset verification inquiry and response system for all asset verification requests. To facilitate electronic communication of information, the Partner Bank (Box 14) provides an interface in communication with the asset verification service. The interface is preferably configured to receive security data and at least one asset query from the asset verification service, and to return to a receiving interface at the asset verification system, asset verification data.

An Associate Bank (Box 16) is partially integrated with the asset verification system, providing some electronic access to account information, but still requiring manual access requests, for example via facsimile, to some records. Associate Banks (Box 16) utilize the asset verification system for a portion of the asset verification requests they receive, and may or may not provide full electronic access to their account information. For example, an Associate Bank (Box 16) may receive requests from the asset verification system electronically via an interface and communications link such as the internet, but only provide verification reports or responses via facsimile transmissions.

Finally, an Independent Bank (Box 18) is not integrated with the asset verification system at all, and provides no electronic account access. Information requested from an Independent Bank (Box 18) by the asset verification system must be requested manually, via mail or facsimile transmission.

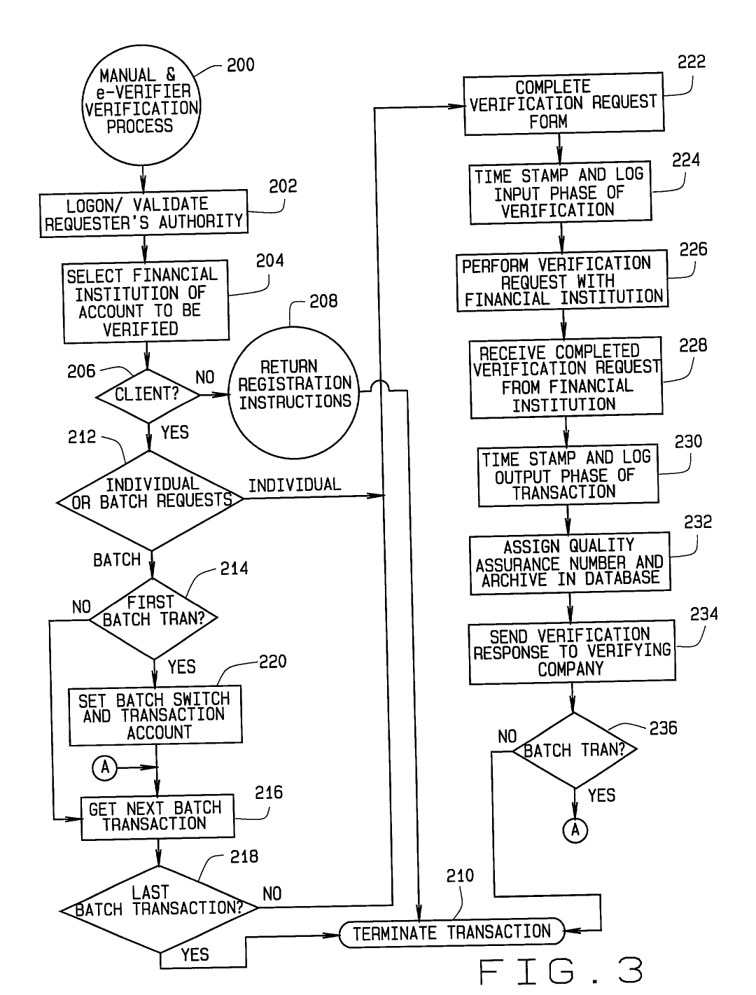

As seen in FIG. 3, the request for verification of assets (Box 200) is initiated by a logon to the asset verification system (Box 202), wherein the request is validated as originating from a subscriber to the system, or otherwise authorized user. Information contained in the request for verification of assets which identifies the financial institution at which the asset is held is identified (Box 204). This identified information is utilized to determine if the asset verification system is contracted with the financial institution to provide asset verification services (Box 206). If the asset verification system is not contracted with the identified financial institution, a response is prepared (Box 208), and the transaction is terminated (Box 210).

If the asset verification system is contracted with the identified financial institution to provide asset verification services, the system next determines if the request for asset verification is a batch request containing a number of individual requests for asset verification, or an individual asset verification request (Box 212). For batch requests, the asset verification system determines if the request is the first request in a batch (Box 214). If the request is not the first request in a batch, the system identifies the next request in the batch (Box 216), and determines if the request is the last request in the batch (Box 218). Alternatively, if the request is the first request in a batch of requests, the asset verification system identifies the number of requests for asset verification contained in the batch request, and starts a transaction counter (Box 220) before proceeding to determine if the request is the last request in the batch (Box 218). If the request is the last request, as determined from the transaction counter, the transaction is terminated (Box 210).

Individual asset verification requests and asset verification requests contained in a batch of asset verification requests are handled by the asset verification system the same way. Asset verification requests are first processed into a standardized electronic verification request form (Box 222). This may be done either manually by an operator, or electronically. Each asset verification request is provided with a time stamp and recorded in an audit log (Box 224) for tracking. Next, the standardized asset verification request is conveyed to the appropriate financial institution, either electronically to a suitable interface, by mail, or by fax depending upon the capabilities of the financial institution.

Upon receiving a response from the financial institution (Box 228) through a return interface, the asset verification system associates a time stamp with the response, and provides an entry in the audit log (Box 230) for tracking purposes. The response is further assigned a quality assurance number and archived in a database for subsequent retrieval (Box 232). The asset verification system generates an asset verification response, and communicates the response through an outgoing interface to the entity which originated the asset verification request (Box 234). Finally, the asset verification system determines if the request was part of a batch transaction (Box 236), requiring additional requests to be conveyed to financial institutions, or if it was an individual request, at which point the transaction is terminated (Box 210).

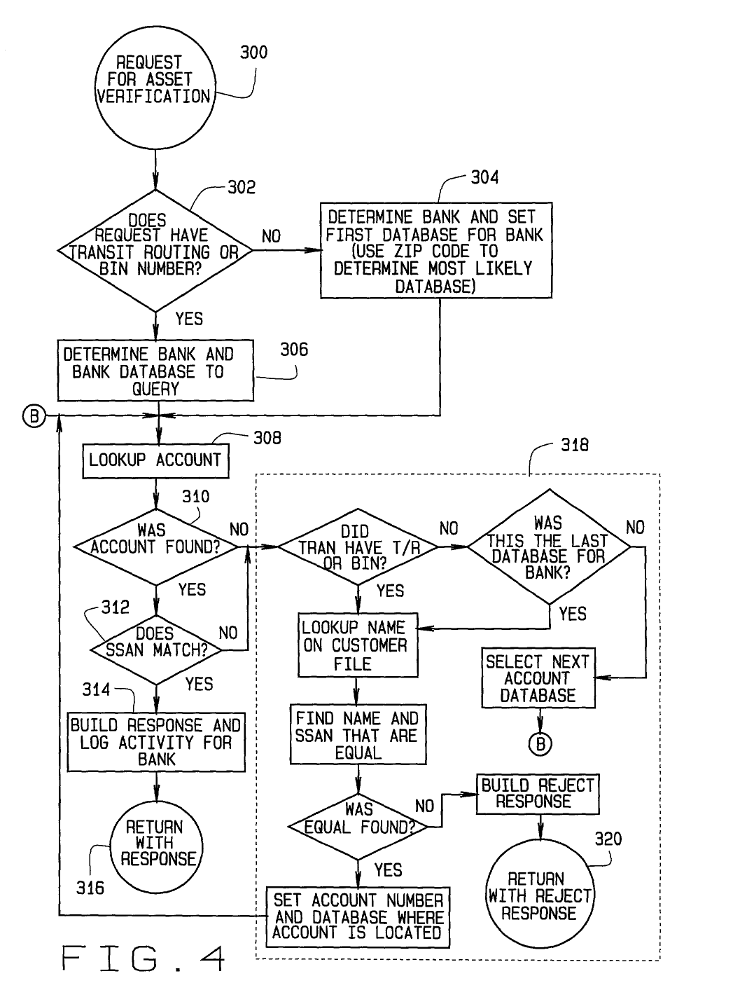

Turning next to FIG. 4, an exemplary asset verification processes carried out by a financial institution after receiving a request for asset verification from the asset verification system (Box 300). Initially, the financial institution reviews the received request to determine if a transit routing or bank identification number (BIN) is supplied (Box 302). If no transit routing or BIN is supplied with the request, the financial institution selects a first bank and database to search for the requested asset. (Box 304). If present, the transit routing or BIN identifies the appropriate bank and database to search for the requested asset. (Box 306).

Next, the financial institution searches the selected bank and database to locate the identified account. (Box 308). If found, (Box 310) security checks are carried out to confirm that the account is the one identified in the request (Box 312). Upon confirmation, the financial institution generates an asset verification response, and may generate an internal log of the activity, (Box 314), before returning the asset verification response to the requesting asset verification system (Box 316).

If the identified account is not found, or if the security checks do not indicate the account located is the correct account, the financial institution may utilize additional information contained in the asset verification request to attempt to fulfill the asset verification request using an account search algorithm (Box 318). For example, as shown in FIG. 4, the financial institution may attempt to identify the requested account by associating a customer name provided in the asset verification request with an account listed in the databases of the financial institution. This may require searching a number of different databases at the financial institution, and confirming the account information with one or more security checks before releasing any asset verification responses or generating a request rejection in the event an account cannot be identified or confirmed. (Box 320). Those of ordinary skill in the art will recognize that the process by which each financial institution carries out the search of its own records for purposes of providing the asset verification information to the asset verification system of the present invention may vary within the scope of the present invention. However, each financial institution associated with the asset verification system of the present invention must provide, at a minimum, the ability to receive asset verification requests, and to generate a suitable response to each such received request.

It is anticipated that the exchange of data between the requesting party, the asset verification system, and a financial institution may be encrypted or may utilize other forms of secure communications, thereby preventing unauthorized access to confidential and sensitive financial information.

The asset verification system of the present invention may optionally provide an interactive voice response system configured to provide information about the asset verification system, including the services provided by the system, the registration process, frequently asked questions, and any additional information which is desired to be provided to potential new customers. Potential customers for an asset verification system include: verification requesters, financial institutions, and service providers that assist individuals and corporations in completing financial transactions.

An optional registration process to become an electronic verifier (e-Verifier) provides the asset verification system with a secure means of identifying the verifier. Each e-Verifier is required to sign a contract with the asset verification system provider stating that they will only request verifications when properly authorized by the applicant. The asset verification system provider may randomly audit verification requests for the proper documentation. When the e-Verifier has signed the contract, the asset verification provider issues a Verifier Identification Number and requires each individual user of the system to have a personalized User ID and Password. Once registered as an e-Verifier, the requester no longer needs to mail or fax VOD request forms to the asset verification system processing center. Instead, they employ the following procedure to request verification of the assets contained in a deposit account or other securities holding:

1. Log-in to the asset verification system using Verifier Identification Number, User ID, and Password;

2. Complete VOD request Submission Form by providing at least the following information: account holder Name, Address, and SSN, Account Number, and Account Type;

3. Submit the verification request

The verification request is then routed by the asset verification system to the identified financial institution and upon receipt of the verification information, the asset verification system logs the verification for future auditing and quality control purposes before delivering the completed verification information to the verifier.

If the verifier ever has a problem with a transaction, the asset verification system provider will have a Customer Service Center available to provide professional problem resolution. Optionally, the same Customer Service Center may handle all manual verifications.

The asset verification system optionally implements an audit procedure to ensure the accuracy and privacy of asset verification requests. The audit procedure is implemented using conventional sampling techniques, may be periodic, or may be random. In general, the audit procedure utilized by the asset verification system of the present invention involves the following steps: After submission of an electronic verification request, notification will be sent to the originating party requesting the original asset verification authorization forms. The originating party must provide either the original, or an acceptable copy thereof (i.e. facsimile) of the proper authorization forms to the asset verification service within a predetermined period of time. If the authorization forms do not contain the required authorization elements, i.e. authorizing signatures or other documentation, the originating party will be prevented from further accessing the system, and proper entities (i.e. financial institutions, etc) may be notified of the improper asset requests. Those of ordinary skill in the art will recognize that a variety of audit procedures may be similarly implemented with the asset verification system of the present invention to ensure the accuracy and legitimacy of the asset authorization requests.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

1. A method for providing an asset verification service between a requesting party and at least one financial institute holding at least one asset, comprising:
receiving at an asset verification system an asset verification request from said requesting party, said asset verification request identifying at least one financial institution and at least one related asset;
communicating said asset verification request from said asset verification system to said identified financial institute holding said at least one related asset;
receiving at said asset verification system an asset verification response from said identified financial institute;
generating an asset verification report at said asset verification system based upon said asset verification response received from said financial institution; and
transmitting said asset verification report to said requesting party.

2. The method of claim 1 for providing an asset verification service wherein said asset request from said requesting party is received electronically at said asset verification system.

3. The method of claim 1 for providing an asset verification service wherein said asset verification request is communicated electronically from said asset verification service to said financial institute.

4. The method of claim 1 for providing an asset verification service wherein said asset verification is received electronically at said asset verification system from said financial institute.

5. The method of claim 1 for providing an asset verification service wherein said asset verification request is received via facsimile.

6. The method of claim 1 for providing an asset verification service wherein said asset verification request is received via postal delivery.

7. The method of claim 1 wherein prior to the step of communicating said asset verification request from said asset verification system to said identified financial institute holding said at least one related asset, said received asset verification response is converted to an electronic format.

8. A system for providing an asset verification service between at least one requesting party and at least one financial institution holding at least one asset record, comprising:
a first interface at said asset verification service configured to receive requesting party identification and an asset query;
a second interface at said at least one financial institution, said second interface in communication with said asset verification service, said second interface configured to receive security data and said asset query from said asset verification service and to return asset verification response data to said asset verification service; and
a third interface at said asset verification service configured to receive said asset verification response data and to generate an asset verification report.

9. The system of claim 8 for providing an asset verification service further including a fourth interface at said asset verification service, said fourth interface configured to communicate said asset verification report to said at least one requesting party.
